(19) United States
(12) Patent Application Publication
(10) Pub. No.: US 2012/0149625 A1
(43) Pub. Date: Jun. 14, 2012

(54) Detergent Composition

(75) Inventors: Ole Simonsen, Soeborg (DK); Lise Munch Mikkelsen, Roedovre (DK); Jurgen Carsten Franz Knotzel, Copenhagen (DK); Astid Benie, Vaerloese (DK)

(73) Assignee: Novozymes A/S, Bagsvaerd (DK)

(21) Appl. No.: 13/391,832

(22) PCT Filed: Sep. 21, 2010
(86) PCT No.: PCT/EP2010/063908

§ 371 Date: Feb. 23, 2012

(30) Foreign Application Priority Data
Sep. 25, 2009 (EP) 09171421.2
Dec. 22, 2009 (EP) 09180426.0
Feb. 12, 2010 (EP) 10153476.6

(51) Int. Cl. C11D 3/386

(52) U.S. Cl. 510/226; 510/392; 510/320

(57) ABSTRACT

The addition of a protease inhibitor to a particulate protease-containing detergent composition can improve its detergency and the inhibitor can improve the in-wash stability of the protease in a solution of the detergent.

### FIELD OF THE INVENTION

The present invention relates to a particulate detergent composition and a protease, to methods of preparing such a detergent composition, and to a method of removing egg-containing soiling from a soiled article.

### BACKGROUND OF THE INVENTION

It is well known to incorporate proteases in detergent compositions to improve the detergency in laundry washing and/or automatic dishwashing (ADW). Proteases may tend to show poor long term storage stability in some liquid detergents, and the addition of a reversible protease inhibitor such as a peptide aldehyde is disclosed in WO94/04651, WO95/25791, WO98/13458, WO98/13459, WO98/13460, WO98/13462, WO07/141,736, WO07/145,963 and WO09/102,854.

### SUMMARY OF THE INVENTION

The inventors have found that the addition of a protease inhibitor to a protease-containing detergent composition can improve its detergency. Accordingly, the invention provides a particulate detergent composition, a protease and a protease inhibitor. The invention also provides use of the particulate detergent composition for washing of soiled articles.

The invention also provides a method of preparing a particulate detergent composition, comprising:
a) providing a particulate detergent composition and a protease, and
b) adding a protease inhibitor to the detergent composition in an amount which is effective for increasing detergency.

The order of addition is arbitrary and includes separate or combined addition of protease, inhibitor and detergent components.

Further, the invention provides a method of preparing a detergent composition, comprising:
a) testing at least one protease and at least one protease inhibitor by determining detergency of a detergent composition comprising the protease with and without the protease inhibitor,
b) selecting a protease and a protease inhibitor such that the detergency with the inhibitor is higher than the detergency without the inhibitor, and
c) preparing a detergent composition comprising the selected protease and the selected inhibitor.

Finally, the invention provides a method of removing egg-containing soiling from a soiled article, comprising washing the article with a solution of a detergent comprising a protease and a protease inhibitor.

### DETAILED DESCRIPTION OF THE INVENTION

### Protease

The protease may be of animal, vegetable or microbial origin, including chemically or genetically modified mutants. It may be a serine protease e.g. a 10R protease; an S1A protease or a metal-protease, e.g. an alkaline microbial protease or a trypsin-like protease. Examples of alkaline proteases are subtilisins, especially those derived from Bacillus, e.g., subtilisin Novo, subtilisin Carlsberg, subtilisin BPN', subtilisin 309, subtilisin 147 and subtilisin 168 (described in WO89/06279) and Protease PD138 (WO93/18140). Examples are described in WO98/020115, WO01/44452, WO01/58275, WO01/58276, WO03/006602 and WO04/099401. Examples of trypsin-like proteases are trypsin (e.g. of porcine or bovine origin) and the Fusarium protease described in WO89/06270 and WO94/25583. Other examples are the variants described in WO92/19729, WO98/20115, WO98/20116, WO98/34946, patent application EP09171308.1 and mixtures of proteases.

Examples of commercially available proteases (peptidases) include Kannase™, Everlase™ Esperase™, Alcalase™, Neutrase™, Durazym™, Savinase™, Ovozyme™, Liquanase™, Coronase™, Polarzyme™, Pyrase™, Pancreatic Trypsin NOVO (PTN), Bio-Feed™ Pro and Clear-Lens™ Pro (all available from Novozymes A/S, Bagsvaerd, Denmark). Other commercially available proteases include Ronozyme™ Pro, Maxatase™, Maxacal™, Maxapem™, Optic-lean™, Properase™, Purafect™, Purafect™, Purafact Prime™, Excellase™, FN2™, FN3™ and FN4™ (available from Genencor International Inc., Gist-Brocades, BASF, or DSM). Other examples are Primase™ and Duralase™. Balp R, Blap S and BlapX available from Henkel are also examples.

Some specific variants of subtilisin 309 may comprise modification of the amino acid residues listed below, using the numbering according to BPM prime:

S9R + V68A + S99G + Q245R + N261D
S9R + A15T + *97aG + P131S + Q137H
S9R + A15T + V68A + Q245R
S9R + A15T + H120N + P131T + N218D
S9R + A15T + V68A, H120N, N218D, Q245R
S9R + A15T + V68A + S99G + Q245R + N261D
S9R + A15T + G61E + V68A + A98S + S99G + Q245R
S9R + A15T + V68A + H120D + P131S + Q137H + Q245R
S9R + A15T + V68A + S99G + A194P + Q245R + N261D
S9R + A15T + V68A + S99G + A228V + Q245R + N261D
S9R + A15T + V68A + N76D + S99G + Q245R + N261D
S9R + A15T + *97aG + S101G + P131S + Q137H
S9R + A15T + *97aG + P131S + Q137H + N218D
S9R + A15T + S101G + H120N + P131T + N218D
S9R + A15T + V68A + S101G + Q245R
S9R + A15T + V68A + N218S + Q245R
S9R + A15T + V68A + N218D + Q245R
S9R + A15T + V68A + N218G + Q245R
S9R + A15T + V68A + N218V + Q245R
S9R + A15T + V68A + N76D + Q245R
S9R + A15T + V68A + Q245R + N261D
S9R + A15T + N62D + *97aG + P131S + Q137H
S9R + A15T + N62D + V68A + Q245R
S9R + A15T + V68A + A194P + Q245R
S9R + A15T + V68A + A228V + Q245R
S9R + A15T + V68A + A230V + Q245R
S9R + A15T + G61E + V68A + A98S + S99G + N218D + Q245R
S9R + A15T + G61E + N76D + V68A + A98S + S99G + Q245R
S9R + A15T + V68A + S99G + A194P + N218D + Q245R + N261D
S9R + A15T + V68A + S99G + N218D + A228V + Q245R + N261D
S9R + V68A + S99G + N218G + Q245R + N261D
S9R + V68A + S99G + N218V + Q245R + N261D
S9R + A15T + V68A + S99G + A194P + N218S + Q245R + N261D
S9R + A15T + V68A + S99G + A194P + N218G + Q245R + N261D
S9R + A15T + V68A + S99G + A194P + N218V + Q245R + N261D
S9R + A15T + V68A + H120V + N218D + Q245R
S9R + A15T + V68A + H120Q, N218D + Q245R
S9R + A15T + V68A + N76D + N218D + Q245R
S99SE
V68A + S106A
Y167A + R170S + A194P

In general the properties of the chosen enzyme(s) should be compatible with the selected detergent, (i.e. pH-optimum, compatibility with other enzymatic and non-enzymatic ingredients, etc.), and the enzyme(s) should be present in effective amounts.

### Inhibitor

The inhibitor may have an inhibition constant, Ki (M, mol/L) of 1E−12-1E−03; 1E−11-1E−04; 1E-10⁻¹E−05; 1E−10-1E−06; 1E−12—9.99E−9; 1E−09—1E−07. The protease inhibitor may be a peptide aldehyde, a protease inhibitor of the peptide or protein type or a boronic acid derivative.

The peptide aldehyde is preferably specially designed for each protease active site. The peptide aldehyde may comprise 2, 3, 4, 5 or 6 amino acid residues. The N-terminal of the peptide aldehyde may be H or protected by an N-terminal protection group, preferably selected from formyl, acetyl, benzoyl, trifluoroacetyl, fluoromethoxy carbonyl, methoxysuccinyl, aromatic and aliphatic urethane protecting groups, benzyloxycarbonyl, t-butyloxycarbonyl, adamantyloxycarbonyl, p-methoxybenzyl carbonyl (MOZ), benzyl (Bn), p-methoxybenzyl (PMB) or p-methoxyphenyl (PMP), methyl carbamate or a methyl urea group.

Thus, the peptide aldehyde may have the formula B₂—B₁—B₀—R wherein:

R is hydrogen, CH₃, CX₃, CHX₂, or CH₂X, wherein X is a halogen atom;
B₀ is a single amino acid residue;
B₁ is a single amino acid residue; and
B₂ consists of one or more amino acid residues (preferably one or two), optionally comprising an N-terminal protection group.

In the above formula, B₀ may be an L or D-amino acid with an optionally substituted aliphatic or aromatic side chain, preferably D- or L-Tyr (p-tyrosine), m-tyrosine, 3,4-dihydroxyphenylalanine, Leu, Phe, Val, Met, Nva or Nle.

B₁ may be a residue with a small optionally substituted aliphatic side chain, preferably Ala, Cys, Gly, Pro, Ser, Thr, Val, Nva, or Nle.

B₂ may be either one residue B2 with either a small aliphatic side chain (preferably, Gly, Ala, Thr, Val or Leu) or Arg or Gln; optionally comprising a N-terminal protection group, selected from the “aromate” or “small” protection groups described below; or B2 may be two residues B3-B2′ where B2′ is like B2 above and B3 is a residue with an hydrophobic or aromatic side chain (preferably Phe, Tyr, Trp, m-tyrosine, 3,4-dihydroxyphenylalanine, phenylglycine, Leu, Val, Nva, Nle or lle) optionally comprising a N-protection group selected from the “small” protection groups described below. Most preferably B2 allows for placing an aromatic or hydrophobic system in the “fourth position” counting from the aldehyde, this could be N-“aromate”-B2, where B2 is like described above and “aromate” protection group contain an aromatic or hydrophobic group such as benzyloxycarbonyl (Cbz), p-methoxybenzyl carbonyl (MOZ), benzyl (Bn), benzoyl (Bz), p-methoxybenzyl (PMB) or p-methoxyphenyl (PMP). Alternatively most preferred, B₂ may be a dipeptide of the form N-“small”-B3-B2′, where B2′ and B3 are like described above with a “small” N-terminal protection group attached such as formyl, acetyl, methyloxy, or methyloxylcarbonyl.

Alternatively the peptide aldehyde may have the formula as described in WO98/13459:

Z—B—NH—CH(R)—C(O)H wherein

B is a peptide chain comprising from 1 to 5 amino acid moieties;

Z is an N-capping moiety selected from the group consisting of phosphoramidate [(R″O)₂(O)P-], sulfenamide [(SR″)₂″], sulfonamide [(R″(O)₂S-], sullonic acid, [SO₃H], phosphinamide [(R″)₂(O)P-], sulfamoyl derivative [R″O(O)₂S-], thiourea [(R″)₂N(O)C-], thiocarbamate [R″O(S)C-], phosphonate [R″-P(O)OH], amidophosphate [R″O(OH)(O)P-], carbamate (R″O(O)C—), and urea (R″NH(O)C—), wherein each R″ is independently selected from the group consisting of straight or branched C₁-C₆ unsubstituted alkyl, phenyl, C₇-C₉ alkylaryl, and cycloalkyl moieties, wherein the cycloalkyl ring may span C₄-C₈ and may contain one or more heteroatoms selected from the group consisting of O, N, and S (preferred R″ is selected from the group consisting of methyl, ethyl, and benzyl); and R is selected from the group consisting of straight or branched C₁-C₆ un-substituted alkyl, phenyl, and C₇-C₉ alkylaryl moieties.

Preferred R moieties are selected from the group consisting of methyl, iso-propyl, sec-butyl, iso-butyl, —C₆H₅, —CH₂—C₆H₅, and —CH₂CH₂—C₆H₅, which respectively may be derived from the amino acids Ala, Val, He, Leu. PGly (phenylglycine), Phe, and HPhe (homophenylalanine) by converting the carboxylic; acid group to an aldehyde group. While such moieties are therefore not amino acids (and they may or may not have been synthesized from an amino acid precursor), for purposes of simplification of the exemplification of inhibitors useful here, the aldehyde portion of the inhibitors are indicated as derived from amino acids by the addition of “H” after the analogous amino acid [e.g., “—AlaH” represents the chemical moiety “—NHCH(CH₃)C(O)H”].

Preferred B peptide chains are selected from the group consisting of peptide chains having the amino acid sequences according to the general formula:

Z-A⁵-A⁴-A³-A²-A¹-NH—CH(R)—C(O)H

such that the following amino acids, when present, are
A¹ is selected from Ala, Gly;
A², if present, is selected from Val, Ala, Gly, lle;
A³, if present, is selected from Phe, Leu, Val, lle;
A⁴, if present, is any amino acid, but preferably is selected from Gly, Ala;
A⁵, if present, is any amino acid, but preferably is Gly, Ala, Lys.

The aldehydes may be prepared from the corresponding amino acid whereby the C-terminal end of said amino acid is converted from a carboxylic group to an aldehyde group. Such aldehydes may be prepared by known processes, for instance as described in U.S. Pat. No. 5,015,627, EP185930, EP583534, and DE3200812.

The N-terminal end of said protease inhibitors is protected by one of the N-capping moiety protecting groups selected from the group consisting of carbamates, ureas, sulfonamides, phosphonamides, thioureas, sulfenamides, sulfonic adds, phosphinamides, thiocarbamates, amidophosphates, and phosphonamides. However, in one embodiment of the invention, the N-terminal end of said protease inhibitor is protected by a methyl, ethyl or benzyl carbamate [CH₃O(O)C—; CH₃CH₂O—(O)C—; or C₆H₅CH₂O—(O)C-], methyl, ethyl or benzyl urea [CH₃NH—(O)C—; CH₃CH₂NH—(O)C—; or C_{E}:H₅CH NH—(O)C-], methyl, ethyl or benzyl sulfonamide [CH₃SO₂—; CH₃CH₂SO₂—; or C₆H₅CH₂SO₂], and methyl, ethyl or benzyl amidophosphate [CH₃O(OH)(O)P—; CH₃CH₂O(OH)(O)P—; or C₆H₅CH₂O(OH)(O)P-] groups.

More particularly, the peptide aldehyde may be Z-RAY-H, Ac-GAY-H, Z-GAY-H, Z-GAL-H, Z—VAL-H, Z-VAL-CF₃, Z-GAF-H, Z-GAF-CF₃, Z-GAV-H, Z-GGY-H, Z-GGF-H, Z—RVY—H, Z-LVY—H, Ac-LGAY-H, Ac—FGAY-H, Ac—YGAY-H, Ac—FGAL-H, Ac—FGAF-H, Ac—FGVY—H, Ac—FGAM-H, Ac—WLVY—H, MeO-CO-VAL-H, MeNCO-VAL-H, MeO-CO-FGAL-H, MeO-CO-FGAF-H, MeSo₂—FGAL-H, MeSO₂—VAL-H Ph C H₂O(OH)(O)P-VAL-H, EtSO₂—FGAL-H, PhCH₂SO₂—VAL-H, PhCH₂O(OH)(O)P-LAL-H, PhCH₂O(OH)(O)P-FAL-H, and Meo(OH)(O)P-LGAL-H, wherein amino acids are denoted by standard single letter notification (ex F=Phe, Y=Tyr, L=Leu ect), Z is benzyloxycarbonyl, Me is methyl, Et is ethyl, and Ac is acetyl.

Alternatively, the peptide aldehyde may have the formula as described in PCT/EP2009/064972:

P—O-(Aᵢ-X′)ₙ-Aₙ₊₁-Q
wherein Q is hydrogen, CH₃, CX₃, CHX₂, or CH₂X, wherein X is a halogen atom;
wherein one X′ is the “double N-capping group” CO, CO—CO, CS, CS—CS or CS—CO, most preferred urido (CO), and the other X′ es are nothing,
wherein n=1-10, preferably 2-5, most preferably 2,
wherein each of Aᵢ and Aₙ₊ᵢ is an amino acid residue having the structure:
—NH—CR—CO— for a residue to the right of X≡CO—, or
—CO—CR—NH— for a residue to the left of X≡CO—
wherein R is H— or an optionally substituted alkyl or alkylaryl group which may optionally include a hetero atom and may optionally be linked to the N atom, and wherein P is hydrogen or any C-terminal protection group.

Examples of such peptide aldehydes include α-MAPI, β-MAPI, F-urea-RVY—H, F-urea-GGY-H, F-urea-GAF-H, F-urea-GAY-H, F-urea-GAL-H, F-urea-GA-Nva-H, F-urea-GA-Nle-H, Y-urea-RVY—H, Y-urea-GAY-H, F—CS—RVF—H, F—CS—RVY—H, F—CS-GAY-H, Antipain, GE20372A, GE20372B, Chymostatin A, Chymostatin B, and Chymostatin C. Further examples of peptide aldehydes are disclosed in EP08169063.8 and PCT/EP2009/053580, WO94/04651, WO98/13459, WO98/13461, WO98/13462, WO07/145,963, (P&G) hereby incorporated by reference.

The protease inhibitor of the peptide or protein type may be RASI, BASI, WASI (bifunctional alpha-amylase/subtilisin inhibitors of rice, barley and wheat) or 012 or SSI, or may be a polypeptide with at least 80%, 85%, 90%, 91%, 92%, 93%, 94%, 95%, 96%, 97%, 98% or 99% amino acid sequence identity.

The boronic acid derivative may have the formula B(OH)₂—C₆H₄—CO—R wherein —C₆H₄— has bonds attached in the m- or p-position, and R is selected from the group consisting of hydrogen, hydroxy, C₁-C₆ alkyl substituted C₁-C₆ alkyl, C₁-C₆ alkenyl and substituted C₁-C₆ alkenyl, e.g. 4-formyl-phenyl-boronic acid (4-FPBA). Other examples are disclosed in WO96/041859, hereby incorporated by reference.

The protease, inhibitor and detergent components may be formulated separately or in combinations.

### Dosages

The detergent may be added in the wash (g det/L wash (wash liquor or detergent solution)): 0.01-100; most preferred: 1-15.

The protease may be present at a concentration in detergent (mol/kg det) of: 1E−09-2E−03; 1E−09-5E−04; 1E−08-3E−04; 1E−08-8E−04; 1E−07-5E−04; 1E−07-2E−04; or 5E−07-1.5E−04. Or the protease may be present at a concentration corresponding to Savinase 12T in detergent (w %) of: 0,0001%-50%; 0.001%-25%; 0.01%-20%; or 0.05%-15%. For ADW the ranges may be (mol/kg det): 1E−07-2E−03; 2E−07-8E−04; 4E−07-5E−04; or 1E−06-5E−04. For ADW, corresponding to Savinase 12T in detergent (w %): 0,001%-50%; 0.01%-25%; 0.02%-20%; or 0.1%-15%. For laundry, the ranges may be (mol/kg det): 1E−09-5E−04; 1E-08-2E−04; 1E−07-1.5E−04; or 2E−07-5E−05. For Laundry corresponding to Savinase 12T in detergent (w %): 0,0001%-50%; 0.001%-20%; 0.01%-15%; or 0.05%-10%.

The protease may be present at a concentration in wash (nM): 0.1-2000; 0.1-1000; 0.1-700, 0.2-750 or 0.2-500. For ADW the ranges may be (nM) 5-2000; 10-1000; or 20-750. For laundry the ranges may be (nM) 0.1-200; 0.1-150; or 0.2-100.

The inhibitor to protease ratio (mol inhibitor/mol protease): 0.1-1000; 0.1-500; 0.2-50; 0.2-25, e.g. 0.5-15 or 1.5-5.

The inhibitor concentration in detergent (mol/kg det): 1E−10-1; 1E−09-0.01; 1E−08-1E−03; 1E−07-1E−03; or 1E−06-5E−04. For ADW the ranges may be (mol/kg det) 1E−08-1; 2E−08-0.5; 5E−08-0.01; 1E−07-5E−03; or 5E−07-5E−04. For Laundry, the ranges may be (mol/kg det) 1E−10-1; 1E−09-0.1; 1E−08-0.01; 2E−08-1E−03; or 1E−08-1E−04. Or the inhibitor like a peptide aldehyde may be present in the concentration in detergent (ppm): 1E−05-5E+05 or 1E−05-1E+05; 1E−04-2.5E+05 or 1E−04-1000; 2E−03-5000 or 0.01-500; 0.02-5000 or 0.1-500; 0.1-1500 or 1-250. For ADW the ranges may be (ppm) 1E−03-5E+05; 1E−03-2.5E+05; 0.01-5000; 0.02-2500; or 0.2-1500. For Laundry the ranges may be (ppm) 1E−05-5E+05; 1E-04-5E+04; 2E−03-5000; 0.01-500; or 0.1-250.

The concentration of inhibitor in detergent (mol/kg det) divided by the inhibition constant (Ki, M) (L/kg): 0.01-1E+08; 0.1-2E+07; 1-2E+06 or 0.1-1E+06; 1-1E+06, 10-1E+05 or 5-2E+05. For ADW the ranges may be (L/kg): 0.5-1E+08; 1-2E+07; 10⁻²E+06; or 25-1E+06. For laundry the ranges may be (L/kg): 0.01-1E+08; 0.1-2E+07; 1-1E+06; or 5-2E+05.

### Detergent Composition

The particulate detergent composition may be a granulate or powder, or a powder/granulate pressed to a tablet, briquette, soapbar, etc. The protease and the inhibitor may be added to the detergent separately or as a co-granulate where they are contained in the same granules. The inhibitor can also be sprayed onto the powder as a solution or dispersion, e.g. in nonionic surfactant or added to the detergent in any other way.

The composition may be in the form of a tablet, bar or pouch, including multi-compartment pouches. The composition can be in the form of a powder, for example a free-flowing powder, such as an agglomerate, spray-dried powder, encapsulate, extrudate, needle, noodle, flake, or any combination thereof.

Non-dusting granulates of proteases and/or inhibitor, optionally comprising detergent components, may be produced, e.g., as disclosed in U.S. Pat. No. 4,106,991 and U.S. Pat. No. 4,661,452. They may be coated by methods known in the art, e.g., as disclosed in WO00/01793, WO01/025412, WO01/25411, WO01/04279, WO04/067739 and WO04/003188.

When dissolved in water at a concentration of 1, 2, 3, 4, or 5 g/L, the detergent solution may show a pH of 6-11, particularly 7-9 for laundry and 7-11 for ADW.

The detergent composition may be formulated as a laundry or dishwashing detergent for hand or machine washing. In some embodiments, it may be a liquid or granular detergent.

The detergent composition contains a surfactant and/or a builder, typically both.

In the detergent compositions, the protease may be present in an amount corresponding to (mg enzyme protein per Liter wash); 0.001-100 mg/L; 0.02-50 mg/L; or 0.05-25 mg/L. For ADW the ranges may be 0.1-100 mg/L; 0.2-50 mg/L; or 0.5-25 mg/L. For laundry the ranges may be 0.001-100 mg/L; 0.002-20 mg/L; or 0.005-10 mg/L.

The detergent may be formulated as described in WO09/092,699, EP1705241, EP1382668, WO07/001,262, U.S. Pat. No. 6,472,364, WO04/074419 or WO09/102,854.

Other useful detergent formulations are described in WO09/124,162, WO09/124,163, WO09/117,340, WO09/117,341, WO09/117,342, WO09/072,069, WO09/063,355, WO09/132,870, WO09/121,757, WO09/112,296, WO09/112,298, WO09/103,822, WO09/087,033, WO09/050,026, WO09/047,125, WO09/047,126, WO09/047,127, WO09/047,128, WO09/021,784, WO09/010,375, WO09/000,605, WO09/122,125, WO09/095,645, WO09/040,544, WO09/040,545, WO09/024,780, WO09/004,295, WO09/004,294, WO09/121,725, WO09/115,391, WO09/115,392, WO09/074,398, WO09/074,403, WO09/068,501, WO09/065,770, WO09/021,813, WO09/030,632, and WO09/015,951.

### Other Detergent Components

The detergent may comprise a metal care agent, such as benzatrioles, metal salts and complexes and silicates, e.g. as described in WO09/102,854.

The detergent composition may comprise at least one glycosyl hydrolase family 61(GH61) polypeptides, where the detergent composition may be adapted for specific uses such laundry, in particular household laundry, dish washing or hard surface cleaning. The detergent composition may comprise at least one GH 61 polypeptide, wherein the enzyme detergency benefit of said detergent is enhanced by at least 1 delta remission unit as compared to a detergent without the GH 61 polypeptide. The remission (R) of the test material is measured at 460 nm using a Zeiss MCS 521 VIS spectrophotometer. The measurements are done according to the manufacturer's protocol. Remission values were calculated as the difference between reference and sample at the chosen wavelength:

delta_{—}R=Rₛₐₘₚₗₑ−R_{ref}

The detergent may include one or more of the enzymes described in the section “Detergency enzymes”.

The detergent may comprise one or more polymers. Examples are modified polysaccharides such as carboxymethylcellulose, ethyl(hydroxyethyl) cellulose, carboxymethyl inulin, grafted starch co-polymers, poly(vinylpyrrolidone), poly (ethylene glycol), poly (propylene glycol), poly(vinyl alcohol), poly(vinylpyridine-N-oxide), poly(vinylimidazole), polycarboxylates such as polyacrylates, maleic/acrylic and 2-Acrylamido-2-methylpropane sulfonic acid copolymers and lauryl methacrylate/acrylic acid copolymers

The detergent may contain a bleaching system. It may be a bleaching system based on chlorine- or bromine releasing agents which may be present in 1-5 wt % of the detergent. If desirable a bleach catalyst, such as manganese complex, e.g. Mn-Me TACN, as described in EP458397 or the sulphonimines of U.S. Pat. No. 5,041,232 and U.S. Pat. No. 5,047,163 may be incorporated. This may be presented in the form of an encapsulate separately from the percarbonate bleach granule. Cobalt catalysts may also be used. It may also be a bleaching system comprising a H₂O₂ source such as perborate or percarbonate, which may be combined with a peracid-forming bleach activator such as tetraacetylethylenediamine or nonanoyloxybenzenesulfonate. Alternatively, the bleaching system may comprise peroxyacids of e.g. the amide, imide, or sulfone type. A dishwash detergent typically contains 10-30% of bleaching system.

The detergent compositions of the present invention may comprise one or more bleaching agents. In particular powdered detergents may comprise one or more bleaching agents. Suitable bleaching agents include other photobleaches, pre-formed peracids, sources of hydrogen peroxide, bleach activators, hydrogen peroxide, bleach catalysts and mixtures thereof. In general, when a bleaching agent is used, the compositions of the present invention may comprise from about 0.1% to about 50% or even from about 0.1% to about 25% bleaching agent by weight of the subject cleaning composition. Examples of suitable bleaching agents include:

(1) other photobleaches for example Vitamin K3;
(2) preformed peracids: Suitable preformed peracids include, but are not limited to, compounds selected from the group consisting of percarboxylic acids and salts, percarbonic acids and salts, perimidic acids and salts, peroxymonosulfuric acids and salts, for example, Oxone, and mixtures thereof. Suitable percarboxylic acids include hydrophobic and hydrophilic peracids having the formula R—(C═O)O—O-M wherein R is an alkyl group, optionally branched, having, when the peracid is hydrophobic, from 6 to 14 carbon atoms, or from 8 to 12 carbon atoms and, when the peracid is hydrophilic, less than 6 carbon atoms or even less than 4 carbon atoms; and M is a counterion, for example, sodium, potassium or hydrogen;
(3) sources of hydrogen peroxide, for example, inorganic perhydrate salts, including alkali metal salts such as sodium salts of perborate (usually mono- or tetra-hydrate), percarbonate, persulphate, perphosphate, persilicate salts and mixtures thereof. In one aspect of the invention the inorganic perhydrate salts are selected from the group consisting of sodium salts of perborate, percarbonate and mixtures thereof. When employed, inorganic perhydrate salts are typically present in amounts of from 0.05 to 40 wt %, or 1 to 30 wt % of the overall composition and are typically incorporated into such compositions as a crystalline solid that may be coated. Suitable coatings include, inorganic salts such as alkali metal silicate, carbonate or borate salts or mixtures thereof, or organic materials such as water-soluble or dispersible polymers, waxes, oils or fatty soaps. Useful bleaching compositions are described in U.S. Pat. No. 5,576,282 and U.S. Pat. No. 6,306,812;
(4) bleach activators having R—(C═O)-L wherein R is an alkyl group, optionally branched, having, when the bleach activator is hydrophobic, from 6 to 14 carbon atoms, or from 8 to 12 carbon atoms and, when the bleach activator is hydrophilic, less than 6 carbon atoms or even less than 4 carbon atoms; and L is leaving group. Examples of suitable leaving groups are benzoic acid and derivatives thereof—especially benzene sulphonate. Suitable bleach activators include dodecanoyl oxybenzene sulphonate, decanoyl oxybenzene sulphonate, decanoyl oxybenzoic acid or salts thereof, 3,5,5-trimethyl hexanoyloxybenzene sulphonate, tetraacetyl ethylene diamine (TAED), nonanoyloxybenzene sulphonate (NOBS), sodium nonanoyloxybenzene sulphonate (SNOBS), sodium benzoyloxybenzene sulphonate (SBOBS) and the cationic peroxyacid precursor (SPCC) described in U.S. Pat. No. 4,751,015. Suitable bleach activators are also disclosed in WO98/17767. While any suitable bleach activator may be employed, in one aspect of the invention the subject cleaning composition may comprise NOBS, TAED or mixtures thereof; and
(5) bleach catalysts that are capable of accepting an oxygen atom from peroxyacid and transferring the oxygen atom to an oxidizable substrate are described in WO08/007,319 (hereby incorporated by reference). Suitable bleach catalysts include, but are not limited to: iminium cations and polyions; iminium zwitterions; modified amines; modified amine oxides; N-sulphonyl imines; N-phosphonyl imines; N-acyl imines; thiadiazole dioxides; perfluoroimines; cyclic sugar ketones and mixtures thereof. In some embodiments the bleach catalyst may be an organic catalyst selected from the group consisting of organic catalysts having the following formulae:

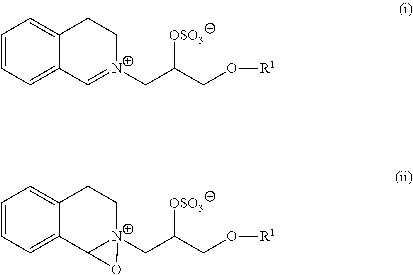

(iii) and mixtures thereof; wherein each R¹ is independently a branched alkyl group containing from 9 to 24 carbons or linear alkyl group containing from 11 to 24 carbons, preferably each R¹ is independently a branched alkyl group containing from 9 to 18 carbons or linear alkyl group containing from 11 to 18 carbons, more preferably each R¹ is independently selected from the group consisting of 2-propylheptyl, 2-butyloctyl, 2-pentylnonyl, 2-hexyldecyl, n-dodecyl, n-tetradecyl, n-hexadecyl, n-octadecyl, iso-nonyl, iso-decyl, iso-tridecyl and isopentadecyl. The bleach catalyst will typically be comprised in the detergent composition at a level of from 0.0005% to 0.2%, from 0.001% to 0.1%, or from 0.005% to 0.05% by weight.

When present, the peracid and/or bleach activator is generally present in the composition in an amount of from about 0.1 to about 60 wt %, from about 0.5 to about 40 wt % or from about 0.6 to about 10 wt % based on the composition. One or more hydrophobic peracids or precursors thereof may be used in combination with one or more hydrophilic peracid or precursor thereof.

The amounts of hydrogen peroxide source and peracid or bleach activator may be selected such that the molar ratio of available oxygen (from the peroxide source) to peracid is from 1:1 to 35:1, or 2:1 to 10:1.

The detergent may contain an organic catalyst such as the zwitterionic sulfate derivatives of 3,4-dihydroisoquinoline described in WO07/001,262.

The detergent may also contain other conventional detergent ingredients such as e.g. fabric conditioners including clays, foam boosters, suds suppressors, anti-corrosion agents, soil-suspending agents, anti-soil redeposition agents, dyes, bactericides, optical brighteners, hydrotropes, tarnish inhibitors, calcium sources, or perfumes.

### Builder

The detergent may be a compact granular (powdered) detergent comprising a) at least about 10%, preferably from 15 to 60% by weight of the composition, of surfactant selected from anionic surfactants, non ionic surfactants, soap and mixtures thereof; b) from about 10 to 80% by weight of the composition, of a builder, preferably from 20% to 60% where the builder may be a mixture of builders selected from i) phosphate builder, preferably less than 20%, more preferably less than 10% even more preferably less than 5% of the total builder is a phosphate builder; ii) a zeolite builder, preferably less than 20%, more preferably less than 10% even more preferably less than 5% of the total builder is a zeolite builder; iii) citrate, preferably 0 to 5% of the total builder is a citrate builder; iv) polycarboxylate, preferably 0 to 5% of the total builder is a polycarboxylate builder v) carbonate, preferably 0 to 30% of the total builder is a carbonate builder and vi) sodium silicates, preferably 0 to 20% of the total builder is a sodium silicate builder; c) from about 0% to 25% by weight of the composition, of fillers such as sulphate salts, preferably from 1% to 15%, more preferably from 2% to 10%, more preferably from 3% to 5% by weight of the composition, of fillers.

The detergent may contain a detergent builder. The amount may be above 5%, above 10%, above 20%, above 30%, above 40% or above 50%, and may be below 80%, 65%. In a dishwash detergent, the level of builder is typically 40-65%, particularly 50-65%.

The builder may particularly be a chelating agent that forms water-soluble complexes with Ca and Mg. The strength of the complex formed between the builder and Ca⁺⁺ and/or Mg++, expressed as the log K value (either given as the equilibrium or stability constant or as the conditional stability constant at a given pH), may be in the range 3-8, particularly 5-8. The stability constant may be measured at 25° C. and ionic strength 0.1M, and the conditional stability constant may be measured at the same conditions at pH 8.5 or 9.

The builder may contain an amino group and may be, e.g., amino carboxylate, amino-polycarboxylate or a phosphonate. It may be a monomeric molecule comprising one, two or three amino groups (typically secondary or tertiary amino groups), and it may contain two, three, four or five carboxyl groups. Examples of suitable builders are methyl glycine diacetic acid (MGDA), glutamic acid N,N-diacetic acid (N,N-dicarboxymethyl glutamic acid tetrasodium salt, GLDA), nitrilotriacetic acid (NTA), diethylene triamine pentaacetic acid (DTPA), ethylenediaminetetraacetic acid (EDTA), Ethylenediamine-N,N′-disuccinic acid (EDDS), N-(1,2-dicarboxyethyl)-D,L-aspartic acid (IDS) and N-(2-hydroxyethyl)iminodiacetic acid (EDG), and salts thereof.

The builder preferably has a buffering capacity (also termed reserve alkalinity) greater than 4 (the number of equivalents of a strong acid required to change the pH of one litre of a buffer solution by one unit, keeping the total amount of the acid and the salt in the buffer constant).

The builder may be an environmentally friendly sequesterant, e.g. as described in WO09/102,854. Suitable environmentally friendly sequesterants include one or more of amino acid-based sequesterants, succinate-based sequesterants, citric acid and salts thereof.

Examples of suitable amino acid based compounds include MGDA (methyl-glycine-diacetic acid), and salts and derivatives thereof and GLDA (glutamic-N,N-diacetic acid) and salts and derivatives thereof. Other suitable builders are described in U.S. Pat. No. 6,426,229. Particular suitable builders include; for example, aspartic acid-N-monoacetic acid (ASMA), aspartic acid-N,N-diacetic acid (ASDA), aspartic acid-N-monopropionic acid (ASMP), iminodisuccinic acid (IDA), N-(2-sulfomethyl) aspartic acid (SMAS), N-(2-sulfoethyl) aspartic acid (SEAS), N-(2-sulfomethyl) glutamic acid (SMGL), N-(2-sulfoethyl) glutamic acid (SEGL), N-methyliminodiacetic acid (MI-DA), α-alanine-N,N-diacetic acid (α-ALDA), serine-N,N-diacetic acid (SEDA), isoserine-N,N-diacetic acid (ISDA), phenylalanine-N,N-diacetic acid (PHDA), anthranilic acid-N,N-diacetic acid (ANDA), sulfanilic acid-N,N-diacetic acid (SLDA), taurine-N,N-diacetic acid (TUDA) and sulfomethyl-N,N-diacetic acid (SMDA) and alkali metal salts or ammonium salts thereof. In one aspect, GLDA salts and derivatives thereof may be employed. In one aspect, the tetrasodium salt of GLDA may be employed.

Further examples of suitable builders include N-(hydroxyethyl)-ethylidenediaminetriacetate (HEDTA), diethanolglycine (DEG), 1-Hydroxy Ethylidene-1,1-Diphosphonic Acid (HEDP), Diethylenetriamine Penta (Methylene Phosphonic acid) (DTPMP), Ethylene diamine tetra(methylene phosphonic acid) (EDTMPA) and aminotris(methylenephosphonic acid) (ATMP).

Examples of suitable succinate compounds are described in U.S. Pat. No. 5,977,053. In one aspect, suitable succinate compounds include tetrasodium immino succinate.

Builders may be classified by the test described by M. K. Nagarajan et al., JAOCS, Vol. 61, no. 9 (September 1984), pp. 1475-1478 to determine the minimum builder level required to lower the water hardness at pH 10.5 from 200 ppm (as CaCO₃) to 10 ppm in a solution of a hypothetical detergent dosed at 0.200 percent, given as the weight percent builder in the hypothetical detergent. Alternatively, the determination may be made at pH 8.5 to reflect the lower pH of typical modern laundry detergents. Using this method at either pH, the required level may be 0-25% (strong), 25-35% (medium) or >35% (weak). More preferred are compositions including strong and medium builders, most preferred are compositions with strong builders.

The builder may be a strong builder such as methyl glycine diacetic acid (“MGDA”) or N,N-Dicarboxymethyl glutamic acid tetrasodium salt (GLDA); it may be a medium builder such as sodium tri-poly-phosphate (STPP), or it may be a weak builder such as sodium citrate. More preferred are compositions including strong and medium builders, most preferred are compositions with strong builders. Other examples of builders are zeolite, diphosphate, triphosphate, phosphonate, carbonate, nitrilotriacetic acid, ethylenediaminetetraacetic acid (EDTA), diethylenetriaminepentaacetic acid, alkyl- or alkenylsuccinic acid, soluble silicates and layered silicates (e.g. SKS-6 from Hoechst).

### Surfactant

The detergent composition may comprise one or more surfactants, which may be non-ionic (including semi-polar) and/or anionic and/or cationic and/or zwitterionic. The surfactants are typically present at a level of from 0.1% to 60% by weight. In a dishwash detergent, it is typically from 0.1 to 30%, particularly 2-12%.

When included therein the detergent will usually contain from about 1% to about 40% of an anionic surfactant such as linear alkylbenzenesulfonate, alpha-olefinsulfonate, alkyl sulfate (fatty alcohol sulfate), alcohol ethoxysulfate, secondary alkanesulfonate, alpha-sulfo fatty acid methyl ester, alkyl- or alkenylsuccinic acid or soap.

When included therein the detergent will usually contain from about 0.2% to about 40% of a non-ionic surfactant such as alcohol ethoxylate, nonylphenol ethoxylate, alkylpolyglycoside, alkyldimethylamineoxide, ethoxylated fatty acid monoethanolamide, fatty acid monoethanolamide, polyhydroxy alkyl fatty acid amide, or N-acyl N-alkyl derivatives of glucosamine (“glucamides”). In a dishwash detergent, the level of nonionic surfactants is typically from 2 to 12%.

Typically, the detergent composition comprises (by weight of the composition) one or more surfactants in the range of 0% to 50%, from 2% to 40%, from 5% to 35%, from 7% to 30%, from 10% to 25%, or from 15% to 20%. The composition may comprise from 1% to 15%, from 2% to 12%, 3% to 10%, from 4% to 8%, or from 4% to 6% of one or more surfactants. Surfactants may be anionic surfactants, non-ionic surfactants, cationic surfactants, zwitterionic surfactants, amphoteric surfactants, and mixtures thereof. In some embodiments, the major part of the surfactant is anionic. Suitable anionic surfactants are well known in the art and may comprise fatty acid carboxylates (soap), branced-chain, linear-chain and random chain alkyl sulfates or fatty alcohol sulfates or primary alcohol sulfates or alkyl benzenesulfonates such as LAS and LAB or phenylalknesulfonates or alkenyl sulfonates or alkenyl benzenesulfonates or alkyl ethoxysulfates or fatty alcohol ether sulfates or alpha-olefin sulfonate or dodecenyl/tetradecnylsuccinic acid. The anionic surfactants may be alkoxylated. The detergent composition may also comprise from 1 wt % to 10 wt % of non-ionic surfactant, from 2 wt % to 8 wt %, from 3 wt % to 7 wt %, or less than 5 wt % of non-ionic surfactant. Suitable non-ionic surfactants are well known in the art and may comprise alcohol ethoxylates, and/or alkyl ethoxylaes, and/or alkylphenol ethoxylates, and/or glucamides such as fatty acid N-glucosyl N-methyl amides, and/or alkyl polyglucosides and/or mono- or diethanolamides or fatty acid amides. The detergent composition may also comprise from 0 wt % to 10 wt % of cationic surfactant, from 0.1 wt % to 8 wt %, from 0.5 wt % to 7 wt %, or less than 5 wt % of cationic surfactant. Suitable cationic surfactants are well known in the art and may comprise alkyl quaternary ammonium compounds, and/or alkyl pyridinium compounds and/or alkyl quaternary phosphonium compounds and/or alkyl ternary sulphonium compounds. In some embodiments the composition comprises surfactant in an amount to provide from 100 ppm to 5,000 ppm surfactant in the wash liquor during the laundering process. The composition upon contact with water typically forms wash liquor comprising from 0.5 g/L to 10 g/L detergent composition. Many suitable surface active compounds are available and fully described in the literature, for example, in “Surface-Active Agents and Detergents”, Volumes 1 and 11, by Schwartz, Perry and Berch.

### Detergency

Detergency (wash performance) can be determined by a conventional method wherein a soiled article such as dishware or textile is washed with a solution of the detergent, e.g. by the AMSA method described below. The soiling comprises protein, particularly including blood, cocoa, milk, egg or grass, and mixtures thereof. The washing may be done with a freshly prepared detergent solution, or the solution may be incubated before being used for washing to reflect the in-wash stability of the protease.

### Optional Additional Enzyme

In addition to the protease, the detergent may optionally comprise one or more additional enzymes, particularly an amylase, a lipase, a cellulase, a mannanase, an oxidoreductase, a lyase or mixtures thereof.

### Materials and Methods

### Automatic Mechanical Stress Assay (AMSA) for Laundry or ADW Detergent

Washing experiments are performed in order to assess the wash performance in laundry or dishwashing detergent compositions. The proteases of the present application are tested using the Automatic Mechanical Stress Assay (AMSA). With the AMSA, the wash performance of a large quantity of small volume enzyme-detergent solutions can be examined. The AMSA plate has a number of slots for test solutions and a lid firmly squeezing the laundry sample, the textile to be washed against all the slot openings. During the washing time, the plate, test solutions, textile and lid are vigorously shaken to bring the test solution in contact with the textile and apply mechanical stress in a regular, periodic oscillating manner. For further description see WO02/42740 especially the paragraph “Special method embodiments” at page 23-24.

The laundry experiments are conducted under the experimental conditions specified below:

| | |
|---|---|
| Detergent dosage | 5, g/L |
| Test solution volume | 160 micro L |
| pH | As is |
| Wash time | 20 minutes |
| Temperature | 20° C. (except as noted) |
| Water hardness | 15° dH |

Model detergents and test materials for laundry were as follows:

| | |
|---|---|
| Laundry liquid model | Sodium alkylethoxy sulphate (C-9-15, 2EO) 6.0% |
| detergent | Sodium dodecyl benzene sulphonate 3.0% |
| | Sodium toluene sulphonate 3.0% |
| | Olic acid 2.0% |
| | Primary alcohol ethoxylate (C12-15, 7EO) 3.0% |
| | Primary alcohol ethoxylate (C12-15, 3EO) 2.5% |
| | Ethanol 0.5% |
| | Monopropylene glycol 2.0% |
| | Tri-sodium citrate 2H2O 4.0% |
| | Triethanolamine 0.4% |
| | De-ionized water ad 100% |
| | pH adjusted to 8.5 with NaOH |
| Laundry powder model | Zeolite 42.8% |
| detergent | Sodium carbonate 23.8% |
| | Sodium-LAS 17.8% |
| | Sodium lauryl sulfate 9.5% |
| | Neodol 25-7 (alcohol ethoxylate) 6.0% |
| Test material | CS-37 (Full egg/pigment on cotton) |
| | EMPA117 (Blood/Milk/Ink on cotton/polyester; |
| | heat treated by EMPA Testmaterials AG) |

Water hardness was adjusted to 15° dH by addition of CaCl₂, MgCl₂, and NaHCO₃ (Ca²⁺:Mg^{2+=4:1:7.5}) to the test system. After washing the textiles were flushed in tap water and dried.

The wash performance is measured as the brightness of the colour of the textile washed. Brightness can also be expressed as the intensity of the light reflected from the sample when illuminated with white light. When the sample is stained the intensity of the reflected light is lower, than that of a clean sample. Therefore the intensity of the reflected light can be used to measure wash performance.

Color measurements are made with a professional flatbed scanner (Kodak iQsmart, Kodak, Midtager 29, DK-2605 Brøndby, Denmark), which is used to capture an image of the washed textile.

To extract a value for the light intensity from the scanned images, 24-bit pixel values from the image are converted into values for red, green and blue (RGB). The intensity value (Int) is calculated by adding the RGB values together as vectors and then taking the length of the resulting vector:

Int=\sqrt{r²+g²+b²}

The ADW experiments are conducted under the experimental conditions specified below:

| | |
|---|---|
| Detergent dosage | 3.33 g/L |
| Test solution volume | 160 micro L |
| pH | As is |
| Wash time | 20 minutes |
| Temperature | 50° C. |
| Water hardness | 17° dH |
| Test material | Egg yolk melamine tile (DM-21), |
| | boiled for 1 min in hot water |

The following model detergents are used for ADW experiments:

| | |
|---|---|
| ADW model detergent with MGDA | MGDA(40%) 30% |
| | Sodium carbonate 20% |
| | Sodium percarbonate 10% |
| | Sodium disilicate 5% |
| | TAED 5% |
| | Sokalan CP5 (39.5%) 10% |
| | a) Surfac 23-6.5 (100%) 5% |
| | Sodium Sulfate 15% |
| ADW model detergent with GLDA | GLDA(47%) 30% |
| | Sodium carbonate 20% |
| | Sodium percarbonate 10% |
| | Sodium disilicate 5% |
| | TAED 5% |
| | Sokalan CP5 (39.5%) 10% |
| | b) Surfac 23-6.5 (100%) 5% |
| | Sodium Sulfate 15% |
| ADW model detergent with STPP | STPP 30% |
| | Sodium carbonate 20% |
| | Sodium percarbonate 10% |
| | Sodium disilicate 5% |
| | TAED 5% |
| | Sokalan CP5 (39.5%) 10% |
| | c) Surfac 23-6.5 (100%) 5% |
| | Sodium Sulfate 15% |
| ADW model detergent with Citrate | Sodium citrate 30% |
| | Sodium carbonate 20% |
| | Sodium percarbonate 10% |
| | Sodium disilicate 5% |
| | TAED 5% |
| | Sokalan CP5 (39.5%) 10% |
| | d) Surfac 23-6.5 (100%) 5% |
| | Sodium Sulfate 15% |

Water hardness was adjusted to 17° dH by addition of CaCl₂, MgCl₂, and NaHCO₃ (Ca²⁺:Mg²⁺=4:1:10) to the test system. After washing the egg yolk melamine tiles were flushed in tap water and dried.

The performance is determined as described above for laundry.

### EXAMPLES

### Reference Example

### Determination of Ki

The inhibition constant Ki for the inhibition of Savinase™ (product of Novozymes NS) was determined using standard methods under the following conditions:

Substrate: Succinyl-Alanine-Alanine-Proline-Phenylalanine-para-Nitro-anilide (SucAAPF-pNA, available from Sigma S7388).

Inhibitor: Z-GAY-H, prepared by custom synthesis. The inhibitor was assumed to be 100% pure and the molar concentrations were determined using weighing numbers and molecular weights.

Buffer: 0,1M TRIS (T-1503)+1.5 ml BRIJ solution (15%)/L, pH 9.0

Enzyme concentration in assay: Savinase: 1E−10-1E−09 M. For the specific experiment: [E]₀=6E−09 M.

The initial rate of substrate hydrolysis was determined at 10 substrate concentrations in the range 3E−05 to 6E−04 M and with a double determination without inhibitor present using an automated spectrophotometer (ELISA detection at 25° C.) The resulting curve with concentration of free enzyme (E=delta absorbance) as a function of inhibitor concentration [I]₀ was fitted to the formula E=0.5*([E]₀−[I]₀−Ki+SQRT(([E]₀+[I]₀+Ki)²−4*[E]₀[I]₀) resulting in the specific case a value of Ki=7.4 nM for the inhibition constant between Savinase and Z-GAY-H.

### Example 1

### Detergency Increase with Various Stabilizers in Powder Detergents

Detergency was determined by AMSA for laundry detergent as described above, with various inhibitors and 30 nM protease. Washing was done at 40° C. and water hardness 15° dH with test swatches EMPA117EH and CS-37. The proteases tested were Savinase, Savinase variant Y167A+R170S+A194P, and Alcalase.

Savinase

| | Inhibitor:protease | EMPA117EH | CS-37 |
|---|---|---|---|
| Inhibitor | Molar ratio | % performance | % performance |
| None | — | 100% | 100% |
| Z-RAY-H | 5 | 105% | 106% |
| Z-RVY-H | 5 | 102% | 139% |
| Z-LVY-H | 10 | 111% | 184% |
| Ac-FGAM-H | 10 | 105% | 171% |
| F-Urea-RVF-H | 5 | 107% | 113% |
| Ac-FGAY-H | 5 | 116% | 229% |
| Ac-YGAY-H | 10 | 117% | 212% |
| Ac-FGVY-H | 10 | 121% | 257% |
| Ac-WLVY-H | 10 | 106% | 188% |
| Z-GAL-H | 5 | 108% | 225% |
| Z-GAF-H | 5 | 112% | 248% |
| Z-GAY-H | 5 | 117% | 242% |
| MeOCO-VAL-H | 5 | 109% | 162% |
| 4-FPBA | | 111% | 137% |
| 4-FPBA | 500 | 107% | 128% |

Savinase variant

| | Inhibitor:protease | CS-37 |
|---|---|---|
| Inhibitor | Molar ratio | % performance |
| None | — | 100% |
| Z-RAY-H | 5 | 156% |
| Z-RVY-H | 5 | 152% |
| Z-LVY-H | 10 | 152% |
| Ac-FGAM-H | 10 | 143% |
| F-Urea-RVF-H | 5 | 107% |
| Ac-LGAY-H | 5 | 149% |
| Ac-FGAY-H | 5 | 166% |
| Ac-YGAY-H | 10 | 215% |
| Ac-FGVY-H | 10 | 195% |
| Z-GAL-H | 5 | 169% |
| Z-GAF-H | 5 | 198% |
| Z-GAY-H | 5 | 254% |
| MeOCO-VAL-H | 5 | 156% |

Alcalase

| | Inhibitor | EMPA117EH | CS-37 |
|---|---|---|---|
| Inhibitor | dosage | % performance | % performance |
| None | — | 100% | 100% |
| Z-RAY-H | 5 | 106% | 114% |
| Z-RVY-H | 5 | 104% | 122% |
| Z-LVY-H | 10 | 106% | 95% |
| Ac-FGAM-H | 10 | 105% | 185% |
| Ac-LGAY-H | 5 | 102% | 103% |
| Ac-FGAY-H | 5 | 106% | 152% |
| Ac-YGAY-H | 10 | 100% | 155% |
| Z-GAY-H | 5 | 108% | 147% |
| Z-GAL-H | 5 | 111%* | — |
| Z-GAF-H | 5 | 127%* | — |
| MeOCO-VAL-H | 5 | 111%* | — |

*washed at 20° C.

### Example 2

### Detergency Increase with Various Stabilizers in Liquid Detergents

Detergency was determined with various inhibitors in the laundry liquid model detergent with 30 nM protease (Savinase). Washing was done at 20° C. and water hardness 15° dH with test swatches EMPA117EH.

| | Inhibitor | EMPA117EH |
|---|---|---|
| Inhibitor | dosering | % performance increase |
| None | — | 100% |
| Z-LVY-H | 10 | 122% |
| Ac-FGAM-H | 10 | 127% |
| Ac-LGAY-H | 5 | 102% |
| Ac-FGAY-H | 5 | 115% |
| Ac-FGVY-H | 10 | 110% |
| Ac-WLVY-H | 10 | 104% |
| Z-GAL-H | 5 | 134% |
| Z-GAF-H | 5 | 135% |
| Z-GAY-H | 5 | 114% |
| MeOCO-VAL-H | 5 | 120% |

### Example 3

### Effect of Various Builders

Washing tests were made in four different ADW detergents by the AMSA method described above, using egg yolk melamine plates (boiled). The four detergents contain two strong builders (MGDA and GLDA), a medium builder (STPP) and a weak builder (Na-citrate), respectively. The tests were made with three different proteases at 11 mg EP/L and a protease inhibitor. The proteases tested were Savinase and two Savinase variants, Variant 1 with S9R+A15T+V68A+Q245R and Variant 2 with S9R+A15T+G61E+V68A+A98S+S99G+N218D+Q245R. The protease inhibitor was Z-GAY-H at a molar ratio of 5:1. The detergency tests were made with and without 10 minutes pre-incubation of the detergent solution with protease and inhibitor before washing. The pH of each detergent solution was found to be in the range 10.05-10.2.

ADW Model Detergent with MGDA

| | 0 min | 10 min |
|---|---|---|
| Savinase | 19.63 | 17.28 |
| Savinase + Inhibitor | 25.54 | 21.46 |
| Detergency increase | 130% | 124% |
| Variant 2 | 32.88 | 20.06 |
| Variant 2 + Inhibitor | 34.59 | 28.29 |
| Detergency increase | 105% | 141% |
| Variant 1 | 27.27 | 14.02 |
| Variant 1 + Inhibitor | 32.46 | 21.56 |
| Detergency increase | 119% | 154% |

ADW Model Detergent with GLDA

| | 0 min | 10 min |
|---|---|---|
| Savinase | 20.37 | 18.09 |
| Savinase + Inhibitor | 21.26 | 23.17 |
| Detergency increase | 104% | 128% |
| Variant 2 | 34.75 | 20.60 |
| Variant 2 + Inhibitor | 37.19 | 30.22 |
| Detergency increase | 107% | 147% |
| Variant 1 | 26.84 | 16.26 |
| Variant 1 + Inhibitor | 30.42 | 24.65 |
| Detergency increase | 113% | 152% |

ADW Model Detergent with STPP

| | 0 min | 10 min |
|---|---|---|
| Savinase | 21.35 | 21.74 |
| Savinase + Inhibitor | 30.05 | 21.88 |
| Detergency increase | 141% | 101% |
| Variant 2 | 32.91 | 25.89 |
| Variant 2 + Inhibitor | 30.91 | 29.22 |
| Detergency increase | 94% | 113% |
| Variant 1 | 29.58 | 20.33 |
| Variant 1 + Inhibitor | 32.29 | 25.90 |
| Detergency increase | 109% | 127% |

ADW Model Detergent with Na-citrate

| | 0 min | 10 min |
|---|---|---|
| Savinase | 21.19 | 19.71 |
| Savinase + Inhibitor | 22.16 | 20.58 |
| Detergency increase | 105% | 104% |
| Variant 2 | 27.69 | 30.68 |
| Variant 2 + Inhibitor | 30.51 | 32.80 |
| Detergency increase | 110% | 107% |
| Variant 1 | 27.10 | 23.09 |
| Variant 1 + Inhibitor | 28.80 | 24.37 |
| Detergency increase | 106% | 106% |

The results show that the inhibitor increases the detergency in nearly all cases. The detergency increase is particularly pronounced after pre-incubation in a detergent with a strong builder.

### Example 4

### Detergency Increase with Various Proteases and Inhibitor Ratios

Washing tests were made in detergents with a protease and an inhibitor. Washing conditions were 20 minutes washing at 20° C. and 15° dH. The protease was Savinase at 30 nM. The inhibitor was inhibitor Z-GAY-H at various molar ratios. The results are shown as detergency with the inhibitor relative to detergency at the same conditions without the inhibitor:

### Commercial Liquid Detergents

Two commercial liquid detergents purchased in England were tested with inhibitor:protease molar ratio of 5:1. Protease 10R is described in WO 88/03947. Protease PD138 is described in

| Protease | Liquid detergent | Detergency increase |
|---|---|---|
| Savinase variant V68A + S106A | Commercial 1 | 109% |
| Protease 10R | Commercial 1 | 107% |
| Protease PD138 | Commercial 1 | 107% |
| Savinase variant V68A + S106A | Commercial 2 | 110% |

### Powder Detergent 2

The detergent was a powder detergent with the following composition at 2.5 g/L.

20.05 g Na-citrate dehydrate

### 15.01 g Na-LAS

### 20.01 g SLS

### 3.98 g Neodol 25-7

### 3.02 g Na-sulfate

| | | | 30 nM Savinase | |
|---|---|---|---|---|
| Inhibitor:protease | 30 nM | 30 nM Savinase | variant Y167A + | 30 nM |
| Molar ratio | Savinase | variant S99SE | R170S + A194P | Alcalase |
| None | 100% | 100% | 100% | 100% |
| 1.5 | 132% | 100% | 100% | |
| 3 | 140% | 103% | 107% | 103% |
| 5 | 134% | 106% | 107% | 113% |
| 7.5 | | | | 116% |
| 10 | | | | 119% |

### Liquid Detergent

The liquid detergent described under the AMSA assay was used.

| Inhibitor:protease | 30 nM | 30 nM |
|---|---|---|
| Molar ratio | Savinase | Alcalase |
| None | 100% | 100% |
| 1.5 | 114% | 145% |
| 3 | 109% | 169% |
| 5 | 108% | 146% |
| 7.5 | | 149% |
| 10 | | 147% |

### Powder Detergent 1

The powder detergent described under the AMSA assay was used.

| Inhibitor:protease | 10 nM | 30 nM |
|---|---|---|
| Molar ratio | Savinase | Savinase |
| None | 100% | 100% |
| 0.5 | 112% | 106% |
| 1 | 108% | 105% |
| 1.5 | 111% | 107% |
| 2 | 121% | 108% |
| 3 | 118% | 105% |
| 5 | 118% | 110% |
| 10 | 122% | 107% |
| 15 | 116% | 99% |
| 20 | 104% | 95% |
| 30 | 101% | 83% |
| 50 | 95% | 80% |

1-24. (canceled)

25. A particulate detergent composition which comprises a surfactant and/or a builder, a protease and a protease inhibitor.

26. The detergent composition of claim 25, which comprises the inhibitor in an amount which is effective for increasing detergency or the in-wash stability of the protease in a solution of the detergent.

27. The detergent composition of claim 25, which is a dishwashing detergent comprising a builder.

28. The detergent composition of claim 27, which comprises above 5% of the builder.

29. The detergent composition of claim 25, wherein the builder is a chelating agent which forms water-soluble complexes with Ca and Mg, and wherein the complex with Ca and/or Mg has a stability constant in the range log K=3-8.

30. The detergent composition of claim 25, wherein the builder contains an amino group, particularly one, two or three amino groups.

31. The detergent composition of claim 27, wherein the builder is MGDA, GLDA, NTA or DTPA.

32. The detergent composition of claim 25, which has a pH in the range 6-11 measured in an aqueous solution of 1, 2, 3, 4 or 5 g/L.

33. The detergent composition of claim 25, wherein the protease is a subtilisin or a 10R protease.

34. The detergent composition of claim 25, wherein the inhibitor is present at a concentration in the detergent (mol/kg det) of 1E−09-2E−03; 1E−08-8E−04; 1E−07-5E−04; or 5E−07-1.5E−04.

35. The detergent composition of claim 25, wherein the inhibitor has an inhibition constant to the protease Ki (M, mol/L) of: 1E−12-1E−03; 1E−11-1E−04; 1E−10-1E−05; 1E−10-1E−06; 1E−12-9.99E−9; or 1E−09-1E−07.

36. The detergent composition of claim 25, wherein the inhibitor concentration (mol/kg det) divided by the inhibition constant (Ki, M) (L/kg) is: 0.01-1E+08; 0.1-2E+07; 1-2E+06; or 5-2E+05.

37. The detergent composition of claim 25, wherein the inhibitor is a peptide aldehyde, a protease inhibitor of the peptide or protein type or a boronic acid derivative.

38. The detergent composition of claim 25, wherein the inhibitor is a peptide aldehyde having the formula B2-B1-B0-R wherein:
a) R is hydrogen, CH3, CX3, CHX2, or CH₂X, wherein X is a halogen atom;
b) B0 is a single amino acid residue;
c) B1 is a single amino acid residue; and
d) B2 consists of one or more amino acid residues (preferably one or two), optionally comprising an N-terminal protection group.

39. The detergent composition of claim 25, wherein the inhibitor is a peptide aldehyde having the formula P—O-(Ai-X′)n-An+1-Q wherein
a) Q is hydrogen, CH3, CX3, CHX2, or CH₂X, wherein X is a halogen atom;
b) one X′ is the “double N-capping group” CO, CO—CO, CS, CS—CS or CS—CO, most preferred urido (CO), and the other X'es are nothing,
c) n=1-10, preferably 2-5, most preferably 2,
d) each of Ai and An+1 is an amino acid residue having the structure: —NH—CR—CO— for a residue to the right of X≡CO—, or —CO—CR—NH— for a residue to the left of X≡CO—
e) R is H— or an optionally substituted alkyl or alkylaryl group which may optionally include a hetero atom and may optionally be linked to the N atom, and
f) P is hydrogen or any C-terminal protection group.

40. The detergent composition of claim 25, wherein the inhibitor is Z-RAY-H, Ac-GAY-H, Z-GAY-H, Z-GAL-H, Z-VAL-H, Z-VAL-CF3, Z-GAF-H, Z-GAF-CF3, Z-GAV-H, Z-GGY-H, Z-GGF—H, Z—RVY—H, Z-LVY—H, Ac-LGAY-H, Ac—FGAY-H, Ac—YGAY-H, Ac—FGAL-H, Ac—FGAF-H, Ac—FGVY—H, Ac—FGAM-H, Ac—WLVY—H, MeO-CO-VAL-H, MeNCO-VAL-H, MeO-CO-FGAL-H, MeO-CO-FGAF-H, MeSO₂—FGAL-H, MeSO₂—VAL-H, PhCH₂O(OH)(O)P-VAL-H, EtSO2—FGAL-H, PhCH₂SO2-VAL-H, PhCH₂O(OH)(O)P-LAL-H, PhCH₂O(OH)(O)P-FAL-H, MeO(OH)(O)P-LGAL-H, α-MAPI, β-MAPI, F-urea-RVY—H, F-urea-GGY-H, F-urea-GAF-H, F-urea-GAY-H, F-urea-GAL-H, F-urea-GA-Nva-H, F-urea-GA-Nle-H, Y-urea-RVY—H, Y-urea-GAY-H, F—CS—RVF—H, F—CS—RVY—H, F—CS-GAY-H, Antipain, GE20372A, GE20372B, Chymostatin A, Chymostatin B, or Chymostatin C.

41. The detergent composition of claim 25, which is a laundry detergent comprising a surfactant.

42. The detergent composition of claim 25, wherein the builder is a strong builder, particularly MGDA, GLDA, NTA or DTPA, ASMA, ASDA, ASMP, IDA, SMAS, SEAS, SMGL, SEGL, MIDA, alpha-ALDA, SEDA, ISDA, PHDA, ANDA, SLDA, TUDA or SMDA.

43. A method of removing egg-containing soiling from a soiled article, comprising washing the article with a detergent comprising a protease and a protease inhibitor in an amount which is effective for increasing detergency.

44. The method of claim 43, wherein the article is dishware or textile.
